(19) United States
(12) Patent Application Publication
(10) Pub. No.: US 2008/0241058 A1
(43) Pub. Date: Oct. 2, 2008

(54) PROCESS FOR PRODUCING HYDROGEN WITH PERMSELECTIVE MEMBRANE REACTOR AND PERMSELECTIVE MEMBRANE REACTOR

(75) Inventors: Tadashi HATTORI, Nagoya-City (JP); Toshiyuki Nakamura, Nagoya-City (JP); Nobuhiko Mori, Nagoya-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 11/953,920

(22) Filed: Dec. 11, 2007

Related U.S. Application Data
(63) Continuation of application No. PCT/JP2007/056105, filed on Mar. 23, 2007.

(30) Foreign Application Priority Data
Mar. 23, 2006 (JP) 2006-081803

(51) Int. Cl. C01B 3/26; B01J 23/90

(52) U.S. Cl. 423/651; 422/223

(57) ABSTRACT

A method for producing hydrogen including the steps of supplying a raw material gas from a gas inlet of a reactor tube; producing a gas mixture containing hydrogen, carbon monoxide, and carbon dioxide by a reforming reaction and a shift reaction; recovering, from a discharge outlet of a separator tube, hydrogen being isolated by passing through a permselective membrane into the separator tube from the gas mixture; and discharging other gas components incapable of passing through the permselective membrane from a gas outlet of the reactor. Hydrogen is produced under conditions where α defined by the following equation is in the range of 0.4 to 100:

α={(CO₂)/(CO)²}/K
wherein (CO₂) and (CO) denote the partial pressures of carbon dioxide and carbon monoxide at the gas outlet and K denotes the equilibrium constant of the disproportionation reaction of carbon monoxide at the internal temperature of the reactor tube.

### TECHNICAL FIELD

The present invention relates to a method for producing hydrogen with a permselective membrane reactor from a raw material gas containing at least one component selected from the group consisting of methane, ethane, propane, butane, kerosene, and naphtha, and to a permselective membrane reactor that can suitably be used in the method for producing hydrogen.

### BACKGROUND ART

Hydrogen has been used in large quantities as a basic material gas in petrochemistry. The utilization field of hydrogen is expected to be widened, in combination with its recent appreciation as a clean energy source, especially in the field of fuel cells, and the like. Hydrogen for use in such applications has been produced by reforming of water vapor or carbon dioxide, a partial oxidation reaction, or a decomposition reaction, from raw materials mainly composed of hydrocarbons such as methane, butane, and kerosene and oxygen-containing hydrocarbons (hydrocarbons containing an oxygen atom), such as methanol, ethanol, and dimethyl ether, followed by separation with a permselective membrane that is selectively permeable to hydrogen, such as a palladium alloy film.

In recent years, hydrogen has been produced with a permselective membrane reactor (membrane reactor), in which the reaction and the separation as described above can simultaneously be performed (see, for example, Patent Document 1). Conventionally widely used permselective membrane reactors include a reactor tube that has a gas inlet at one end and a gas outlet at the other end, a porous separator tube that is disposed in the reactor and has a permselective membrane selectively permeable to hydrogen on the surface, and a reforming catalyst that promotes the reforming of a hydrocarbon and/or an oxygen-containing hydrocarbon.

In general, the reforming catalyst has a pellet shape, and is placed between the reactor tube and the separator tube, or is packed in the separator membrane in the state of a packed bed. A raw material gas supplied to the reactor comes into contact with the reforming catalyst and is decomposed into hydrogen and other gases, for example, by steam reforming. For example, in steam reforming of methane, by the promotion of a reforming reaction expressed by the following reaction formula (1) and a shift reaction expressed by the following reaction formula (2), a hydrocarbon (methane) is decomposed into reaction products such as hydrogen, carbon monoxide, and carbon dioxide, and a gas mixture (gaseous product) containing the reaction products can be obtained.

CH₄+H₂O→CO+3H₂ (1)

CO+H₂O→CO₂+H₂ (2)

Hydrogen in the thus obtained gaseous product passes selectively through the permselective membrane into the separator tube and is thereby isolated from the other gas components to be recovered. The other gas components, which do not pass through the permselective membrane, such as carbon monoxide and carbon dioxide are discharged from the gas outlet of the reactor tube to the outside of the reactor.

Since such a permselective membrane reactor can simultaneously perform the chemical reaction using a catalyst and the hydrogen separation with a permselective membrane, it advantageously has a compact structure of an apparatus and reduces the footprint of the apparatus. In addition, hydrogen produced is removed from the reaction system through the permselective membrane, and the equilibrium of the chemical reaction shifts toward the side of product, thereby enabling a lower temperature reaction. A lower temperature reaction consumes less energy during the reaction and inhibits the reactor material from deteriorating. While the specific reaction temperature is in the range of from about 600° C. to about 800° C. in conventional non-membrane reactors, which have no permselective membrane, the reaction temperature is in the range of from about 400° C. to about 600° C. in permselective membrane reactors.

However, in the hydrogen production with the permselective membrane reactors, although the aforementioned merit can be obtained by lowering the reaction temperature, a disproportionation reaction of carbon monoxide expressed by the following reaction formula (3) occurs more frequently, causing deactivation of a catalyst due to coking.

2CO→C+CO₂ (3)

The catalyst deactivation due to coking also occurs in the conventional non-membrane reactors. However, while the main cause of coking is a decomposition reaction of a hydrocarbon in the non-membrane reactors, it is the disproportionation of carbon monoxide in the permselective membrane reactors as described above. In the hydrogen production with the permselective membrane reactors, therefore, in order to inhibit the catalyst deactivation due to coking, a particular measure different from that in the case of using non-membrane reactors is required.

Furthermore, because hydrogen produced by a catalytic reaction moves by diffusion through a gap in a packed catalyst layer, hydrogen cannot move smoothly to the permselective membrane side. This causes a problem of reduction in the efficiency of separation and recovery. Such a problem is particularly significant in permselective membranes having high permeability.

Patent Document 1: JP-A-6-40703

### DISCLOSURE OF THE INVENTION

The present invention has been made in view of the situations described above, and objectives of the present invention are to provide a method for producing hydrogen with a permselective membrane reactor in which disproportionation of carbon monoxide and catalyst deactivation due to coking mainly caused by the disproportionation can be reduced, and the efficiency of separating and recovering hydrogen with a permselective membrane is high and to provide a permselective membrane reactor suitably used in the method.

To achieve the above objectives, according to the present invention, there is provided the following permselective membrane reactor and the following method for producing hydrogen.

[1] A method for producing hydrogen with a permselective membrane reactor that includes a reactor tube having a gas inlet at one end and a gas outlet at the other end; a separator tube disposed in the reactor tube and having a permselective membrane capable of permeating selectively hydrogen formed on its surface and a discharge outlet as an outlet for isolated gas; and a reforming catalyst promoting reforming of at least one component selected from the group consisting of methane, ethane, propane, butane, kerosene, and naphtha, the method comprising the steps of supplying a raw material gas containing at least one component selected from the group consisting of methane, ethane, propane, butane, kerosene, and naphtha from the gas inlet of the reactor tube; producing a gas mixture containing hydrogen, carbon monoxide, and carbon dioxide by a reforming reaction and a shift reaction; recovering, from a discharge outlet of a separator tube, hydrogen being isolated by passing through a permselective membrane into the separator tube from the gas mixture; and discharging other gas components that do not pass through the permselective membrane from the gas outlet of the reactor, wherein hydrogen is produced under conditions where a defined by the following equation is in the range of from 0.4 to 100:

α={(CO₂)/(CO)²}/K

where (CO₂) denotes the partial pressure of carbon dioxide at the gas outlet of the reactor, (CO) denotes the partial pressure of carbon monoxide at the gas outlet of the reactor, and K denotes the equilibrium constant of the disproportionation reaction of carbon monoxide at the internal temperature of the reactor tube.

[2] The method for producing hydrogen with a permselective membrane reactor according to [1], wherein β defined by the following equation is in the range of from 0.05 to 20:

β=a/b

where a denotes the volume of the reforming catalyst layer [cm³] in the permselective membrane reactor, and b denotes the area of the permselective membrane [cm²] in the permselective membrane reactor.

[3] The method for producing hydrogen with a permselective membrane reactor according to [1], wherein the reforming catalyst in the permselective membrane reactor contains at least one metal selected from the group consisting of Fe, Co, Ni, Cu, Mo, Ru, Rh, Pd, Ag, W, Re, Os, Ir, Pt, and Au, and γ defined by the following equation is in the range of from 0.2 to 4000:

γ=c/b

where c denotes the mass of the metal [mg], and b denotes the area of the permselective membrane [cm²].

[4] The method for producing hydrogen with a permselective membrane reactor according to any one of [1] to [3], wherein the permselective membrane is a Pd film or a Pd alloy film and has a thickness of 0.01 to 25 μm.

[5] A permselective membrane reactor comprising a reactor tube that has a gas inlet at one end and a gas outlet at the other end; a separator tube that is disposed in the reactor tube and has a permselective membrane selectively permeable to hydrogen on the surface and a discharge outlet for isolated gas passing through the permselective membrane; and a layer composed of a reforming catalyst that promotes reforming of at least one component selected from the group consisting of methane, ethane, propane, butane, kerosene, and naphtha, wherein β defined by the following equation is in the range of from 0.05 to 20:

β=a/b

where a denotes the volume of the reforming catalyst layer [cm³], and b denotes the area of the permselective membrane [cm²].

[6] A permselective membrane reactor comprising a reactor tube that has a gas inlet at one end and a gas outlet at the other end; a separator tube that is disposed in the reactor and has a permselective membrane selectively permeable to hydrogen on the surface and a discharge outlet for isolated gas passing through the permselective membrane; and a layer composed of a reforming catalyst that promotes reforming of at least one component selected from the group consisting of methane, ethane, propane, butane, kerosene, and naphtha, wherein the reforming catalyst contains at least one metal selected from the group consisting of Fe, Co, Ni, Cu, Mo, Ru, Rh, Pd, Ag, W, Re, Os, Ir, Pt, and Au, and γ defined by the following equation is in the range of from 0.2 to 4000:

γ=c/b

where c denotes the mass of the metal [mg], and b denotes the area of the permselective membrane [cm²].

[7] The permselective membrane reactor according to [5] or [6], wherein the permselective membrane is a Pd film or a Pd alloy film and has a thickness of 0.01 to 25 μm.

According to the present invention, in the hydrogen production with a permselective membrane reactor, disproportionation of carbon monoxide can be reduced, and, catalyst deactivation due to coking mainly caused by the disproportionation can effectively be reduced. Furthermore, the thickness of the catalyst layer and the amount of active components in the catalyst can be optimized to increase the efficiency in separation, and recovery of hydrogen with the permselective membrane.

### BRIEF DESCRIPTION OF THE DRAWINGS

FIG. 1 is a schematic cross-sectional view showing an example of a permselective membrane reactor used in a method for producing hydrogen of the present invention.

FIG. 2 is a schematic diagram of a test apparatus used in an example.

### REFERENCE NUMERALS

1 reactor tube
4 separator tube
5 permselective membrane
6 reforming catalyst
9 gas inlet
10 gas outlet
11 discharge outlet

### BEST MODE FOR CARRYING OUT THE INVENTION

Typical embodiments of the present invention will now be more specifically described with reference to the drawings. However, the present invention is not limited to these embodiments. It should be understood that various alterations and modifications may appropriately be made on the basis of a general knowledge of a person skilled in the art without deviating from the gist of the present invention.

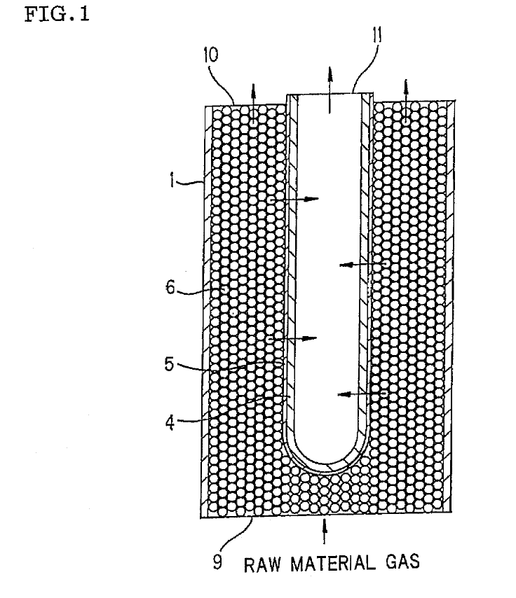

FIG. 1 is a schematic cross-sectional view showing an example of a permselective membrane reactor used in a method for producing hydrogen of the present invention. The permselective membrane reactor includes a reactor tube 1 having a gas inlet 9 at one end and a gas outlet 10 at the other end; a separator tube 4 disposed in the reactor tube 1 and having a bottomed tubular form whose basal portion is porous, a permselective membrane 5 capable of permeating selectively hydrogen formed on its surface, and a discharge outlet 11 as an outlet for an isolated gas; and a reforming catalyst 6 disposed between the reactor 1 and the separator tube 4 and promoting reforming of at least one component selected from the group consisting of methane, ethane, propane, butane, kerosene, and naphtha.

Preferably, the reforming catalyst 6 contains at least one metal selected from the group consisting of Fe, Co, Ni, Cu, Mo, Ru, Rh, Pd, Ag, W, Re, Os, Ir, Pt, and Au as a catalytically active component. The metal, which may be formed into pellets or beads, or may be applied to an alumina pellet substrate, is filled into a gap between the reactor tube 1 and the separator tube 4 in layers, as illustrated in FIG. 1. Preferably, the reactor tube 1 is formed of a material mainly composed of a heat-resistant and heat-conductive metal, such as stainless steel (SUS) or Incoloy. Preferably, the substrate of the porous separator tube 4 having the permselective membrane 5 on the surface thereof may be formed of a porous ceramic material such as titania and alumina or a porous metal such as stainless steel. The permselective membrane 5 is selectively permeable to hydrogen and may suitably be formed of a palladium film or a palladium alloy film such as a palladium-silver alloy film. The permselective membrane 5 has a thickness of preferably 0.01 to 25 μm, more preferably 0.05 to 15 μm, and still more preferably 0.1 to 10 μm. When the thickness is less than 0.01 μm, defects such as pinholes in the permselective membrane 5 increase because it is too thin, and therefore a component other than hydrogen passes through the permselective membrane 5. This reduces the purity of hydrogen thus produced. When the thickness is more than 25 μm, the hydrogen permeation rate decreases with the increase of film thickness. This results in insufficient isolation of hydrogen. The permselective membrane 5 may be disposed on the inner surface of the separator tube 4 instead of the outer surface of the separator tube 4. Alternatively, the permselective membrane 5 may be disposed on both sides of the separator tube 4.

In a method for producing hydrogen of the present invention, hydrogen is produced with a permselective membrane reactor having such a structure. In the permselective membrane reactor, when a raw material gas containing at least one component selected from the group consisting of methane, ethane, propane, butane, kerosene, and naphtha supplied through the gas inlet 9 of the reactor tube 1 comes into contact with the reforming catalyst 6, the component in the raw material gas is decomposed into a hydrogen gas and the other gas components, for example, by steam reforming. For example, as described above, in steam reforming of methane, the reforming catalyst promotes a reforming reaction expressed by the following reaction formula (1) and a shift reaction expressed by the following reaction formula (2). Thus, a hydrocarbon (methane) is decomposed into reaction products such as hydrogen, carbon monoxide, and carbon dioxide, producing a gas mixture (gaseous product) containing the reaction products.

CH₄+H₂O→CO+3H₂ (1)

CO+H₂O→CO₂+H₂ (2)

Hydrogen in the gaseous product passes selectively through the permselective membrane 5 into the separator tube 4 to be isolated from the other gas components and recovered from the discharge outlet 11. The other gas components that do not pass through the permselective membrane 5 such as carbon monoxide and carbon dioxide are discharged to the outside from the gas outlet 10 of the reactor tube 1.

In a method for producing hydrogen of the present invention, hydrogen is produced with such a permselective membrane reactor under specific conditions where the disproportionation of carbon monoxide expressed by the following reaction formula (3) rarely occurs.

2CO→C+CO₂ (3)

Specifically, hydrogen is produced under conditions where α defined by the following equation is in the range of from 0.4 to 100, preferably in the range of from 0.6 to 50, and more preferably in the range of from 1.0 to 20:

α={(CO₂)/(CO)²}/K

where (CO₂) denotes the partial pressure of carbon dioxide at the gas outlet 10 of the reactor tube 1, (CO) denotes the partial pressure of carbon monoxide at the gas outlet 10 of the reactor tube 1, and K denotes the equilibrium constant of the disproportionation reaction of carbon monoxide at the internal temperature of the reactor tube 1.

After intensive research, the present inventors found that hydrogen production under such conditions can reduce the disproportionation of carbon monoxide and, as a result, can effectively reduce catalyst deactivation due to coking mainly caused by the disproportionation.

The equilibrium constant K of the disproportionation of carbon monoxide tends to decrease as temperature rises within a common reaction temperature range (about 400° C. to 600° C.) of the permselective membrane reactor. Furthermore, the α value can be controlled by the flow rate of the raw material gas, the S/C of the raw material gas (steam to carbon ratio: water vapor flow rate (mol/min)/carbon flow rate (mol/min)), the pressure of a space between the reactor tube and the separator tube (pressure on the reaction side), and the internal pressure of the separator tube into which hydrogen passes through the permselective membrane (pressure on the permeation side), as well as the temperature.

When α is less than 0.4, the disproportionation of carbon monoxide cannot sufficiently be inhibited, and thereby the catalyst is deactivated early by coking caused by the disproportionation. On the other hand, α more than 100 generally requires a very high reaction temperature or a very high S/C of the raw material gas (excessive water). This is disadvantageous in terms of energy and efficiency.

Preferably, in a permselective membrane reactor of present invention, β defined by the following equation is in the range from 0.05 to 20:

β=a/b

where a denotes the volume of a layer of the reforming catalyst 6 (catalyst layer) [cm³], and b denotes the area of the permselective membrane 5 [cm²] in the permselective membrane reactor.

Preferably, in a permselective membrane reactor of the present invention, the reforming catalyst 6 contains at least one metal selected from the group consisting of Fe, Co, Ni, Cu, Mo, Ru, Ru, Rh, Pd, Ag, W, Re, Os, Ir, Pt, and Au, and γ defined by the following equation is in the range of from 0.2 to 4000:

γ=c/b

where c denotes the mass of the metal [mg], and b denotes the area of the permselective membrane 5 [cm²].

β and γ in these ranges result in sufficient catalytic activity, a high conversion of a component such as methane, ethane, propane, butane, kerosene, or naphtha contained in the raw material gas, improved isolation of hydrogen by the permselective membrane, and a decrease in the occurrence of catalyst deterioration due to coking. These are more significant when β is in the range of from 0.1 to 10 or γ is in the range of 0.4 to 2000. When β is less than 0.05, or γ is less than 0.2, the amount of catalyst is too small. This results in insufficient catalytic activity, slower progress of the reaction, lower conversion of the component in the raw material gas, and an increase in the occurrence of catalyst deterioration due to coking. When β is more than 20 or γ is more than 4000, the amount of catalyst is too large. Therefore, the permselective membrane reactor becomes uselessly large (thick), exhibiting lower thermal efficiency. Furthermore, a permselective membrane reactor having a large size results in an increase in distance between the catalyst disposed in the vicinity of the inner wall of the permselective membrane reactor and the permselective membrane. This decreases hydrogen isolation efficiency by the permselective membrane. This problem is particularly significant in a permselective membrane having high permeability.

### EXAMPLES

The present invention will now be described in more detail based on examples. However, the present invention is not limited to these examples.

### Examples 1 to 11 and Comparative Examples 1 to 3

Permselective membrane reactors having a structure as illustrated in FIG. 1 and β and γ as shown in the following tables were manufactured. A separator tube 4 included a porous alumina bottomed, tube having a closed end portion (an outer diameter of 10 mm and a length of 75 mm). A palladium-silver alloy film selectively permeable to hydrogen was formed by plating on a surface of the separator tube 4 as a permselective membrane 5. The permselective membrane 5 was composed of 75% by mass of palladium and 25% by mass of silver and had a thickness of 2.5 μm in consideration of a hydrogen permeation performance. Reactor tubes 1 were SUS tubes having openings at both ends and had different inner diameters so that β changes with different amounts of catalyst. As a reforming catalyst 6 was used a commercially available ruthenium-alumina or nickel-alumina catalyst formed into a pellet having a size of about 1 mm. The reforming catalyst 6 was charged between the reactor tube 1 and the separator tube 4 to form a catalyst layer.

### (Evaluation)

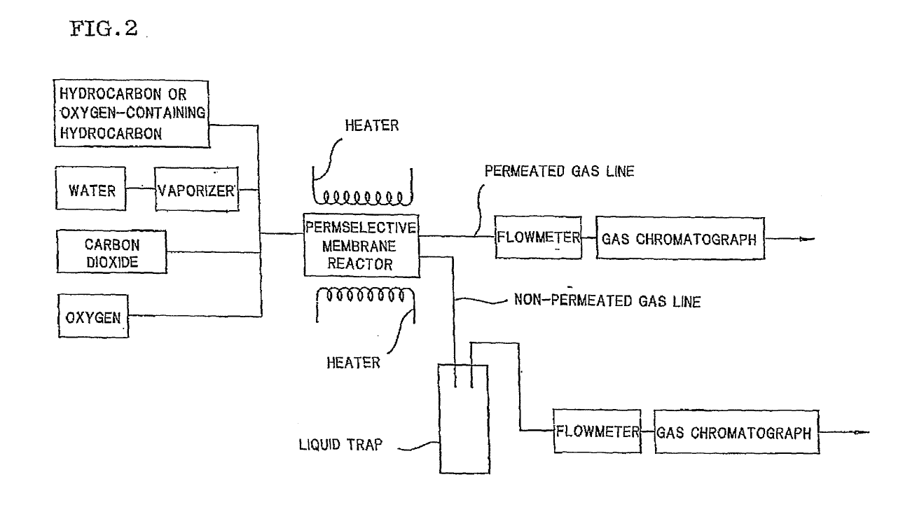

The permselective membrane reactors of Examples 1 to 11 and Comparative Examples 1 to 3 were evaluated with an apparatus illustrated in FIG. 2. This apparatus is connected to raw material gas sources of a hydrocarbon such as methane or butane, an oxygen-containing hydrocarbon such as ethanol, water, carbon dioxide, and oxygen through pipes. These raw material, gases can be selected as necessary and mixed together to be supplied to the permselective membrane reactor. A liquid raw material such as water or kerosene is supplied after gasifying it with a vaporizer.

A permeated gas line and a non-permeated gas line are connected to the permeation side (discharge outlet of the separator tube) and the non-permeation side (gas outlet of the reactor tube), respectively, of the permselective membrane reactor disposed upstream of these lines. The permeated gas line is connected to a flow-meter for measuring the gas flow and a gas chromatograph for determining the gas component, each disposed downstream of the permeated gas line. The non-permeated gas line is also connected to a flowmeter and a gas chromatograph each disposed downstream of the non-permeated gas line. Furthermore, a liquid trap cooled at about 5° C. for trapping a component that is liquid at normal temperature, such as water, is disposed upstream of the flowmeter. A heater is disposed around the permselective membrane reactor so that the permselective membrane reactor can be heated from outside.

In this apparatus, as a raw material gas, methane and water vapor were supplied to each of the permselective membrane reactors according to Examples 1 to 11 and Comparative Examples 1 to 3. Hydrogen was selectively isolated from a reaction product of steam reforming of methane by the water vapor and associated reactions. The S/C of the raw material gas, the reaction temperature of the above reaction, and the pressure on the non-permeation side were adjusted as shown in the following tables to control the value of α to be a value shown in the following tables. Hydrogen was thus produced, and the gas flow rates and the compositions in the permeation side and the non-permeation side were measured to determine the methane conversion and the hydrogen recovery. Furthermore, after 100 hours of reaction, the catalyst was removed from the permselective membrane reactor, and the amount of coke deposited on the catalyst was determined by a combustion method. Tables 1 and 2 show the results.

TABLE 1

| | Comparative | Comparative | Comparative | Example | Example | Example | Example | Example |
|---|---|---|---|---|---|---|---|---|
| | Example 1 | Example 2 | Example 3 | 1 | 2 | 3 | 4 | 5 |
| S/C | 1 | 1 | 1.5 | 2 | 2 | 2 | 2.5 | 2.5 |
| Reaction temp. | 500 | 500 | 550 | 500 | 500 | 550 | 500 | 550 |
| [° C.] | | | | | | | | |
| Non-permeation | 1 | 7 | 3 | 7 | 3 | 9 | 5 | 9 |
| side pressure | | | | | | | | |
| [atm] | | | | | | | | |
| Catalyst | Ru—Al₂O₃ | Ru—Al₂O₃ | Ru—Al₂O₃ | Ru—Al₂O₃ | Ru—Al₂O₃ | Ru—Al₂O₃ | Ru—Al₂O₃ | Ru—Al₂O₃ |
| α | 0.097 | 0.31 | 0.35 | 0.61 | 0.82 | 1.8 | 1.2 | 1.8 |
| β | 0.03 | 0.09 | 0.8 | 0.4 | 0.4 | 0.4 | 0.4 | 0.4 |
| γ | 0.04 | 0.28 | 1.2 | 5 | 5 | 5 | 0.13 | 5 |
| Coke deposit | 102 | 22 | 4.6 | 0.08 | 0.005 | <0.001 | <0.001 | <0.001 |
| [mg/g]* | | | | | | | | |
| Methane conversion | 42 | 32 | 50 | 48 | 65 | 80 | 43 | 84 |
| [%] | | | | | | | | |
| Hydrogen recovery | 97 | 95 | 95 | 95 | 90 | 95 | 85 | 95 |
| [%] | | | | | | | | |

*Coke deposit (mg) per gram of catalyst.

TABLE 2

| | Example 6 | Example 7 | Example 8 | Example 9 | Example 10 | Example 11 |
|---|---|---|---|---|---|---|
| S/C | 3 | 3 | 3 | 3 | 3 | 2.5 |
| Reaction temp. | 550 | 500 | 580 | 550 | 500 | 500 |
| [° C.] | | | | | | |
| Non-permeation | 3 | 7 | 3 | 3 | 7 | 5 |
| side pressure | | | | | | |
| [atm] | | | | | | |
| Catalyst | Ru—Al₂O₃ | Ru—Al₂O₃ | Ni—Al₂O₃ | Ru—Al₂O₃ | Ru—Al₂O₃ | Ru—Al₂O₃ |
| α | 2.3 | 1.2 | 2.8 | 2.3 | 1.2 | 1.2 |
| β | 0.4 | 1 | 2 | 0.003 | 25 | 0.4 |
| γ | 5 | 12 | 400 | 0.04 | 2000 | 5 |
| Coke deposit | <0.001 | <0.001 | <0.001 | <0.001 | <0.001 | <0.001 |
| [mg/g]* | | | | | | |
| Methane conversion | 84 | 91 | 94 | 55 | 60 | 88 |
| [%] | | | | | | |
| Hydrogen recovery | 88 | 95 | 93 | 70 | 85 | 93 |
| [%] | | | | | | |

*Coke deposit (mg) per gram of catalyst.

Comparative Example 1 having α as small as 0.4 or less and a thermodynamic tendency to coke. Furthermore, Comparative Example 1 had also small β and γ, which denoted the amount of catalyst (the volume of catalyst layer and the mass of catalytically active component) per unit area of the permselective membrane. Therefore, the catalyst of Comparative Example 1 suffered from remarkable coking. In Comparative Examples 2 and 3, which had β and γ larger than those of Comparative Example 1, the coke deposit per unit amount of catalyst decreased because of an increase in the amount of catalyst. However, a significant amount of coke was still deposited on the catalyst. In contrast, in Examples 1 to 11, which had α of 0.4 or more, the coke deposit was remarkably reduced as compared with Comparative Examples 1 to 3. In particular, in Examples 3 to 11, which had α of 1.0 or more, the coke deposit was not more than the minimum limit of detection. In Examples 1 to 11, which had different reaction conditions of S/C, the reaction temperature, and the pressure on the non-permeation side, almost no coke was deposited on the catalysts. Hence, it was found that it is important to control α to inhibit coking in the hydrogen production using a permselective membrane reactor.

However, in Example 9, which operated at α of 0.4 or more, coking was reduced, but the methane conversion and the hydrogen recovery were as low as 55% and 70%, respectively. Example 6, which had the same parameters other than β and γ as those of Example 9, had a methane conversion and a hydrogen recovery higher than those of Example 9. This suggests that the catalytic activity in Example 9 having small β and γ was too small to promote the reaction sufficiently. When Example 10 is compared with Example 7, Example 7 had a methane conversion and a hydrogen recovery higher than those of Example 10 although they had the same parameters other than β and γ. This is possibly because a very large β in Example 10 results in the catalyst volume larger than required, leading to an increase in the distance between the catalyst disposed in the vicinity of the inner wall of the permselective membrane reactor and the permselective membrane. This reduces the efficiency of recovering hydrogen produced by the reaction with the permselective membrane. The decrease in hydrogen recovery impairs the reaction promoting effect characteristic of the permselective membrane reactor, finally resulting in a decrease in methane conversion. When Example 4 is compared with Example 11, Example 11 had a methane conversion higher than that of Example 4 although they had the same parameters other than γ. This is possibly because Example 4 having an excessively small γ had insufficient catalytic activity. While large β or γ is preferred in view of the inhibition of coking and the enhancement of catalytic activity, these results show that an excessively large β or γ results in poor hydrogen isolation due to an increase in catalyst volume and therefore low methane conversion.

### INDUSTRIAL APPLICABILITY

The present invention is suitably utilized in a method for producing hydrogen with a permselective membrane reactor from a raw material gas containing at least one component selected from the group consisting of methane, ethane, propane, butane, kerosene, and naphtha, and in a permselective membrane reactor used in the method for producing hydrogen.

1-7. (canceled)

8. A method for producing hydrogen with a permselective membrane reactor that includes a reactor tube having a gas inlet at one end and a gas outlet at the other end; a separator tube disposed in the reactor tube and having a permselective membrane capable of permeating selectively hydrogen formed on its surface and a discharge outlet as an outlet for isolated gas; and a reforming catalyst promoting reforming of at least one component selected from the group consisting of methane, ethane, propane, butane, kerosene, and naphtha, the method comprising the steps of supplying a raw material gas containing at least one component selected from the group consisting of methane, ethane, propane, butane, kerosene, and naphtha from the gas inlet of the reactor tube; producing a gas mixture containing hydrogen, carbon monoxide, and carbon dioxide by a reforming reaction and a shift reaction; recovering, from a discharge outlet of a separator tube, hydrogen being isolated by passing through a permselective membrane into the separator tube from the gas mixture; and discharging other gas components that do not pass through the permselective membrane from the gas outlet of the reactor,
wherein hydrogen is produced under conditions where α defined by the following equation is in the range from 0.4 to 100:
α={(CO₂)/(CO)²}/K
where (CO₂) denotes the partial pressure of carbon dioxide at the gas outlet of the reactor, (CO) denotes the partial pressure of carbon monoxide at the gas outlet of the reactor, and K denotes the equilibrium constant of the disproportionation reaction of carbon monoxide at the internal temperature of the reactor tube.

9. The method for producing hydrogen with a permselective membrane reactor according to claim 8, wherein β defined by the following equation is in the range from 0.05 to 20:
β=a/b
where a denotes the volume of the reforming catalyst layer [cm³] in the permselective membrane reactor, and b denotes the area of the permselective membrane [cm²] in the permselective membrane reactor.

10. The method for producing hydrogen with a permselective membrane reactor according to claim 8, wherein the reforming catalyst in the permselective membrane reactor contains at least one metal selected from the group consisting of Fe, Co, Ni, Cu, Mo, Ru, Rh, Pd, Ag, W, Re, Os, Ir, Pt, and Au, and γ defined by the following equation is in the range of from 0.2 to 4000:
γ=c/b
where c denotes the mass of the metal [mg], and b denotes the area of the permselective membrane [cm²].

11. The method for producing hydrogen with a permselective membrane reactor according to claim 8, wherein the permselective membrane is a Pd film or a Pd alloy film and has a thickness of 0.01 to 25 μm.

12. A permselective membrane reactor comprising a reactor tube that has a gas inlet at one end and a gas outlet at the other end; a separator tube that is disposed in the reactor tube and, has a permselective membrane selectively permeable to hydrogen on the surface and a discharge outlet for isolated gas passing through the permselective membrane; and a layer composed of a reforming catalyst that promotes reforming of at least one component selected from the group consisting of methane, ethane, propane, butane, kerosene, and naphtha,
wherein β defined by the following equation is in the range of from 0.05 to 20:
β=a/b
where a denotes the volume of the reforming catalyst layer [cm³], and b denotes the area of the permselective membrane [cm²].

13. A permselective membrane reactor comprising a reactor tube that has a gas inlet at one end and a gas outlet at the other end; a separator tube that is disposed in the reactor and has a permselective membrane selectively permeable to hydrogen on the surface and a discharge outlet for isolated gas passing through the permselective membrane; and a layer composed of a reforming catalyst that promotes reforming of at least one component selected from the group consisting of methane, ethane, propane, butane, kerosene, and naphtha,
wherein the reforming catalyst contains at least one metal selected from the group consisting of Fe, Co, Ni, Cu, Mo, Ru, Rh, Pd, Ag, W, Re, Os, Ir, Pt, and Au, and γ defined by the following equation is in the range of from 0.2 to 4000:
γ=c/b
where c denotes the mass of the metal [mg], and b denotes the area of the permselective membrane [cm²].

14. The permselective membrane reactor according to claim 12, wherein the permselective membrane is a Pd film or a Pd alloy film and has a thickness of 0.01 to 25 μm.

15. The method for producing hydrogen with a permselective membrane reactor according to claim 9, wherein the permselective membrane is a Pd film or a Pd alloy film and has a thickness of 0.01 to 25 μm.

16. The method for producing hydrogen with a permselective membrane reactor according to claim 10, wherein the permselective membrane is a Pd film or a Pd alloy film and has a thickness of 0.01 to 25 μm.

17. The permselective membrane reactor according to claim 13, wherein the permselective membrane is a Pd film or a Pd alloy film and has a thickness of 0.01 to 25 μm.
